(19) United States
(12) Patent Application Publication
(10) Pub. No.: US 2009/0112688 A1
(43) Pub. Date: Apr. 30, 2009

(54) METHOD AND APPARATUS FOR DETERMINING KEYWORDS FOR AN ADVERTISING CAMPAIGN

(75) Inventors: Matt E. Hart, Lunenburg, MA (US); Roy M. Rosin, Wayne, PA (US)

Correspondence Address: PVF -- INTUIT, INC.;c/o PARK, VAUGHAN & FLEMING LLP, 2820 FIFTH STREET, DAVIS, CA, 95618-7759, US

(73) Assignee: Intuit Inc., Mountain View, CA (US)

(21) Appl. No.: 11/931,181

(22) Filed: Oct. 31, 2007

(51) Int. Cl. G06Q 30/00

(52) U.S. Cl. 705/10

(57) ABSTRACT

A system that for determines keywords to be used in an online advertising campaign for a merchant is presented. During operation, the system sends a request on behalf of the merchant to a user, wherein the request asks the user to search for a product or service offered by the merchant. In response to the request, the system monitors keywords that are used by the user to search for the product or service. Next, the system receives from the user an indication that a subset of the keywords produced search results for the product or service or for a similar product or service. The system then presents to the merchant a report which includes the keywords that the user used to search for the product or service so that the merchant can use one or more of the keywords for the online advertising campaign.

### BACKGROUND

### Related Art

The present invention relates to techniques for determining keywords to be used in an advertising campaign.

As Internet usage increases, more businesses are developing websites to communicate information about their products and services. However, consumers often have difficulty locating a website for a specific business. One solution to this problem is to obtain a listing for the website in a search engine or an Internet directory. Another solution is to use online advertising campaigns to attract customers to the website for the business.

During an online advertising campaign, advertisements can be displayed based on keywords that are used to search for web pages. For example, a search engine typically serves web pages that are related to search terms (or keywords) received from users of a search engine. The cost of context-based advertisements is typically based on the cost of the keywords. For example, the cost can be based on prices for specific keywords, wherein some keywords are more expensive than other words.

Unlike large businesses, small businesses may not have the resources to fund costly advertising campaigns. Hence, small businesses must carefully structure for their online advertising campaigns to stay within their budgets. For example, the keywords selected for online advertising campaigns or the size of banner advertisements must be managed carefully to stay within budget.

Furthermore, customers may describe a given business using keywords that are different than the keywords that the business would describe their own business. For example, a car repair shop may describe itself as a “car repair shop,” but car owners may use the term “mechanic shop”. Hence, if the car repair shop bases their online advertising campaign solely on the keywords “car repair shop,” but customers use the keywords “mechanic shop,” the advertisements for the car repair shop will not be shown to the customers.

### SUMMARY

Some embodiments of the present invention provide a system that determines keywords to be used in an online advertising campaign for a merchant. During operation, the system sends a request on behalf of the merchant to a user, wherein the request asks the user to search for a product or service offered by the merchant. In response to the request, the system monitors keywords that are used by the user to search for the product or service. Next, the system receives from the user an indication that a subset of the keywords produced search results for the product or service or for a similar product or service. The system then presents to the merchant a report which includes the keywords that the user used to search for the product or service so that the merchant can use one or more of the keywords for the online advertising campaign.

In some embodiments, the system presents a web page which allows the merchant to purchase the keywords for the online advertising campaign.

In some embodiments, the user can include: the merchant; a customer of the merchant; a potential customer of the merchant; an employee of a business; a family member of the merchant; a friend of the merchant; and any other person or entity capable of responding to a request to search for a product or service offered by merchant 200.

In some embodiments, while sending the request to the user, the system sends the request to one or more users. The system then obtains contact information for the one or more users from: an account for the merchant within a social network application; an address book for the merchant; an email contact list for the merchant; or a customer list for the merchant.

In some embodiments, prior to sending the request on behalf of the merchant to the user, the system generates the request which prompts the user to search for the product or service offered by the merchant.

In some embodiments, the prompt does not include a business name for the merchant.

In some embodiments, while sending the request on behalf of the merchant to the user, the system sends the request using one or more of: an email message; a message on a website for the merchant; a link on the website for the merchant; a system that displays the request to users; a text message; a phone call; and a piece of postal mail.

In some embodiments, the report includes one or more of: a history of keywords used by the user to search for the product or service; a history of pages that the user visited while searching for the product or service; and the subset of keywords that produced search results for the product or service or for a similar product or service.

In some embodiments, the keywords include geographic information.

In some embodiments, the system analyzes the keywords to determine a set of keywords to use in text for the online advertising campaign. The system then suggests that the merchant use the set of keywords in the text for the online advertising campaign.

In some embodiments, the system analyzes the keywords to determine one or more categories for the business of the merchant. The system then suggests that the merchant use the one or more categories when categorizing the business in a business directory.

In some embodiments, the online advertising campaign is an email advertisement campaign and the keywords are used in a subject line of an email message for the email advertisement campaign.

In some embodiments, an advertisement for the online advertising campaign is to be displayed along with search results produced by a search engine and the keywords are associated with the online advertising campaign.

Some embodiments of the present invention provide a system that determines keywords to be used in an online advertising campaign for a merchant. The system includes a client system; a search engine and a keyword-determination system. The keyword-determination system is configured to: (1) send a request on behalf of the merchant to a user at the client system, wherein the request asks the user to use the search engine to search for a product or service offered by the merchant; (2) monitor keywords that are used by the user to search for the product or service; (3) receive from the user an indication that a subset of the keywords produced search results for the product or service or for a similar product or service; and (4) present to the merchant a report which includes the keywords that the user used to search for the product or service so that the merchant can use one or more of the keywords for the online advertising campaign.

Some embodiments of the present invention provide a system that determines keywords to be used in an online advertising campaign for a merchant. During operation, the system receives a request from the merchant, wherein the request asks a user to search for a product or service offered by the merchant. In response to the request, the system sends keywords that are used by the user to search for the product or service to a keyword-determination system. The system then sends to the keyword-determination system an indication that a subset of the keywords produced search results for the product or service or for a similar product or service. The keywords are then used by the keyword-determination system to generate a report which is presented to the merchant, wherein the report includes the keywords that the user used to search for the product or service, and wherein the merchant can use the one or more of the keywords for the online advertising campaign.

### BRIEF DESCRIPTION OF THE FIGURES

FIG. 1A presents a block diagram illustrating a computer system in accordance with an embodiment of the present invention.

FIG. 1B presents a block diagram illustrating a keyword-determination module in accordance with an embodiment of the present invention.

FIG. 2 illustrates a system that determines keywords to be used in an online advertising campaign for a merchant in accordance with an embodiment of the present invention.

FIG. 3 illustrates a system that determines keywords to be used in in one or more online advertising campaigns for a merchant in accordance with an embodiment of the present invention.

FIG. 4 presents a flow chart illustrating the process of determining keywords to be used in an online advertising campaign for a merchant in accordance with an embodiment of the present invention.

FIG. 5 presents a flow chart illustrating the process of suggesting keywords for text associated with an online advertising campaign in accordance with an embodiment of the present invention.

FIG. 6 presents a flow chart illustrating the process of suggesting categories for a business accordance with an embodiment of the present invention.

FIG. 7 presents a flow chart illustrating another process for determining keywords to be used in an online advertising campaign for a merchant in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. This includes, but is not limited to, volatile memory, non-volatile memory, magnetic and optical storage devices such as disk drives, magnetic tape, CDs (compact discs), DVDs (digital versatile discs or digital video discs), or other media capable of storing computer readable media now known or later developed.

### Overview

In some embodiments of the present invention, a merchant who is signing up for an online advertising campaign is presented with a search engine page and asked to locate their product or service. In other embodiments, the request to locate the product or service is sent to a third party (e.g., potential customers or to a third-party service). The third party then conducts the search for the product or service. In some embodiments, the system captures the search terms used to search for the product or service. In some embodiments, the system notes the search terms that produce search results for the product or service or for a similar product or service. The system then suggests one or more keywords for the merchant to use in an advertisement campaign for the merchant.

### Computer System

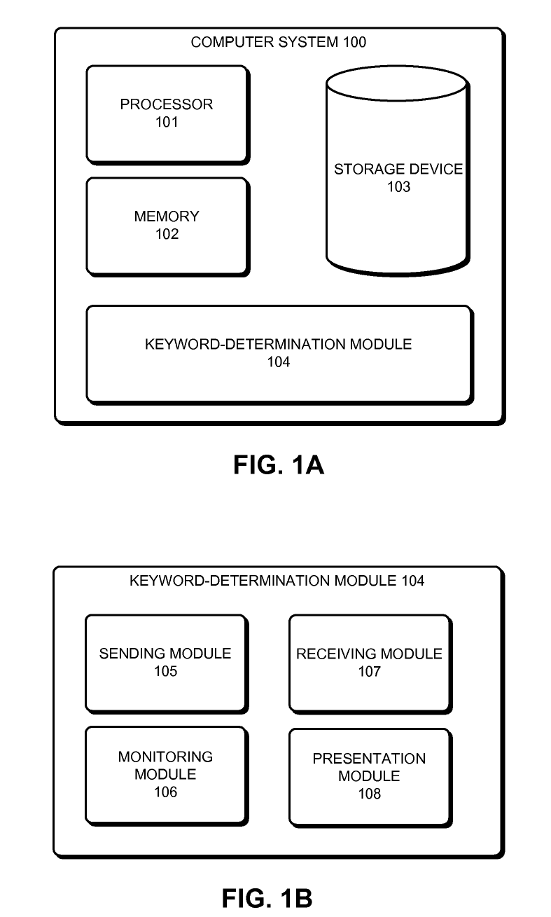

FIG. 1 presents a block diagram illustrating a computer system 100 in accordance with an embodiment of the present invention. Computer system 100 includes processor 101, memory 102, storage device 103, and keyword-determination module 104.

Processor 101 can generally include any type of processor, including, but not limited to, a microprocessor, a mainframe computer, a digital signal processor, a personal organizer, a device controller and a computational engine within an appliance. Memory 102 can include any type of memory, including but not limited to, dynamic random access memory (DRAM), static random access memory (SRAM), flash memory, read only memory (ROM), and any other type of memory now known or later developed. Storage device 103 can include any type of non-volatile storage device that can be coupled to a computer system. This includes, but is not limited to, magnetic, optical, and magneto-optical storage devices, as well as storage devices based on flash memory and/or battery-backed up memory.

In some embodiments of the present invention, keyword-determination module 104 is separate from computer system 100. Note that keyword-determination module 104 is described in more detail with reference to FIGS. 1B-7 below.

FIG. 1B presents a block diagram illustrating keyword-determination module 104 in accordance with an embodiment of the present invention. Keyword-determination module 104 includes sending module 105, monitoring module 106, receiving module 107, and presentation module 108. Sending module 105 is configured to send a request on behalf of the merchant to a user, wherein the request asks the user to search for a product or service offered by the merchant. Monitoring module 106 is configured to monitor keywords that are used by the user to search for the product or service. Receiving module 107 is configured to receive from the user an indication that a subset of the keywords produced search results for the product or service or for a similar product or service. In some embodiments, presentation module 108 is configured to present to the merchant a report which includes the keywords that the user used to search for the product or service so that the merchant can use one or more of the keywords for the online advertising campaign. In other embodiments, presentation module 108 is configured to present a web page that allows a merchant to sign up and/or purchase keywords for the online advertisement campaign.

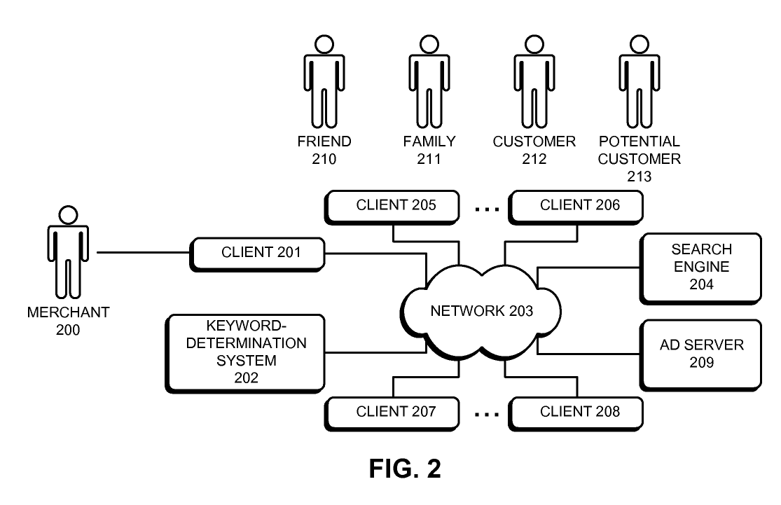

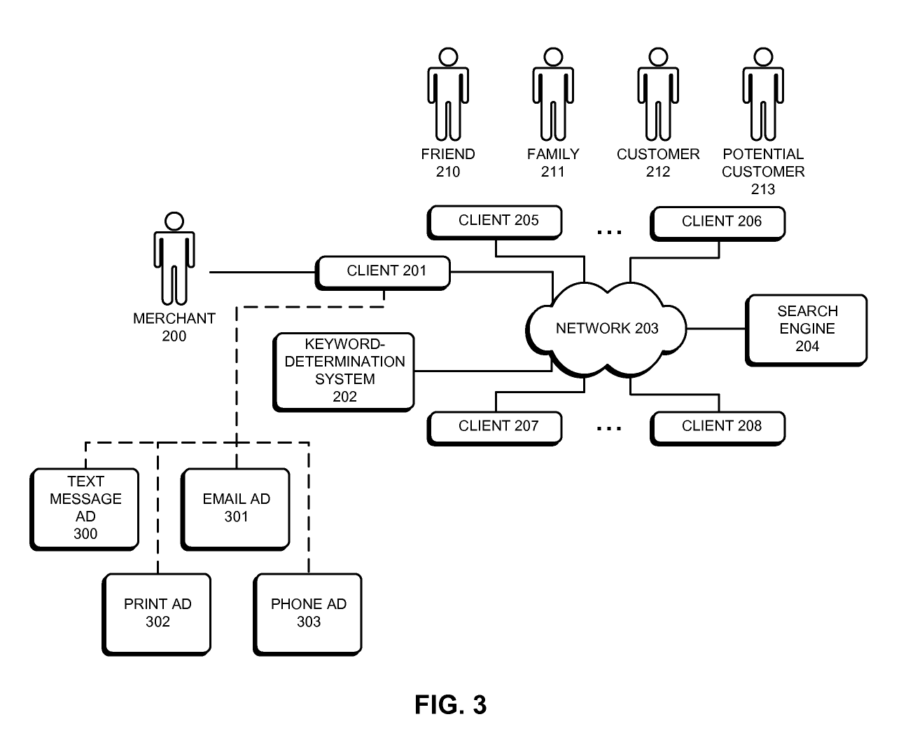

In some embodiments, computer system 100 is part of keyword-determination systems 202 in FIGS. 2-3.

### Determining Keywords for Advertisement Campaigns

FIG. 2 illustrates a system that determines keywords to be used in an online advertising campaign for merchant 200 in accordance with an embodiment of the present invention. More specifically, FIG. 2 includes client computer systems 201 and 205-208, keyword-determination system 202, network 203, search engine 204, and advertisement server 209. Note that although FIG. 2 illustrates four client computer systems, there can be more or fewer client computer systems. Also note that client computer systems 201 and 205-208 can include components illustrated in FIG. 1.

In FIG. 2, merchant 200 desires to start an online advertising campaign to promote products or services offered by merchant 200. In some embodiments, merchant 200 uses client computer system 201 to access keyword-determination system 202. In some embodiments, keyword-determination system 202 is located within client computer system 201 (not shown). In other embodiments, keyword-determination system 202 is separate from client computer system 201. For example, keyword-determination system 202 can be located on a remote server. In these embodiments, client computer system 201 communicates with keyword-determination system 202 communicates through network 203.

Note that network 203 can generally include any type of wired or wireless communication channel capable of coupling together computing nodes. This includes, but is not limited to, a local area network, a wide area network, or a combination of networks. In some embodiments of the present invention, network 203 includes the Internet.

In some embodiments, merchant 200 instructs keyword-determination system 202 to generate a request on behalf of merchant 200 and to send the request to one or more users, wherein the request asks the user to search for a product or service offered by merchant 200. In some embodiments, keyword-determination system 202 sends the request using an email message; a message on a website for the merchant; a link on the website for the merchant; a system that displays the request to users; a text message; a phone call; a piece of postal mail; and any other technique for sending messages now known or later developed. In some embodiments, the request includes a universal resource locator (URL) to an interface (e.g., website) which the user can use to interact with keyword-determination system 202. In some embodiments, the request does not include a business name for merchant 200.

In some embodiments, the one or more users can include, but is not limited to, one or more of: merchant 200; a friend 210 of merchant 200; a family member 211 of merchant 200; a customer 212 of merchant 200; a potential customer 213 of merchant 200; and an employee of a business; and any other person or entity capable of responding to a request to search for a product or service offered by merchant 200. Note that the one or more users can receive the request on client computer systems 205-206.

In some embodiments, keyword-determination system 202 obtains contact information for the one or more users from one or more of: an account for merchant 200 within a social network application; an address book for merchant 200; an email contact list for merchant 200; a customer list for merchant 200; and any other instrument that can contain contact information for users.

In some embodiments, the request is received at a client computer system for the user. In some embodiments, in response to the request, the user uses a client computer system to interact with keyword-determination system 202. For example, friend 210 can use client computer system 205 to interact with keyword-determination system 202.

In some embodiments, keyword-determination system 202 presents an interface to search engine 204, wherein the interface allows the user to enter keywords that can be used to search for products or services offered by merchant 200. In these embodiments, keyword-determination system 202 monitors keywords that are used by the user to search for the products or services offered by merchant 200. Keyword-determination system 202 can also monitor search results that are returned by search engine 204.

In other embodiments, keyword-determination system 202 is a search engine and monitors keywords used to search for products or services offered by merchant 200. Keyword-determination system 202 can also monitor search results that are returned by search engine 204.

In response to receiving the keywords from the user, search engine 204 returns search results based on the keywords. The user can then indicate to keyword-determination system 202 that a subset of the keywords produced search results for the product or service or for a similar product or service. In some embodiments, keyword-determination system 202 monitors one or more of: the keywords used by the user; the search results returned by search engine 204; pages that the user visited while searching for the product or service; and the subset of keywords that produced search results for the product or service or for a similar product or service.

In some embodiments, keyword-determination system 202 generates a report which can include, but is not limited to: a history of keywords used by the user to search for the product or service; a history of pages that the user visited while searching for the product or service; and the subset of keywords that produced search results for the product or service or for a similar product or service. In some embodiments, keyword-determination system 202 presents the report to merchant 200 so that merchant 200 can select one or more of the keywords for the online advertising campaign.

In some embodiments, the keywords include geographic information. In these embodiments, if the merchant only does business in a specified geographic area, keywords that specify this geographic area can be added to the keywords reported to merchant 200. Similarly, if the user specified geographic area in the keyword used to search for the product or service, and if the geographic area is different than the geographic area in which merchant 200 does business, keyword-determination system 202 replaces one or more keywords that the user used to specify a geographic area with the keywords for the geographic area in which merchant 200 does business.

In some embodiments, merchant 200 selects one or more of the keywords from the report to use in an online advertising campaign. In some embodiments, an advertisement for the advertisement campaign is served by advertisement server 209. In some embodiments, advertisement server 209 is included within search engine 204. In other embodiments, advertisement server 209 is a stand-alone advertisement server which can be associated with one or more websites. For example, advertisement server 209 can serve advertisements for a number of blog pages.

In some embodiments, when users access websites that are associated with advertisement server 209, advertisement server 209 serves ads to these users based on the context. For example, if advertisement server 209 is associated with search engine 204, advertisement server 209 serves advertisements based on the keywords used by the user. Similarly, if advertisement server 209 is associated with a news website, advertisement server 209 can serve advertisements based on the content of the page being viewed by the user (e.g., the content of the news article).

FIG. 3 illustrates a system that determines keywords to be used in one or more advertisement campaigns for a merchant in accordance with an embodiment of the present invention. FIG. 2 and FIG. 3 include similar elements and processes, hence, only the differences between FIG. 3 and FIG. 2 are described. More specifically in FIG. 3, instead of using the keywords in an online advertising campaign, the keywords are used in one or more of: a text message advertisement campaign 300, an email advertisement campaign 301, a print advertisement campaign 302, and a phone advertisement campaign 303. In some embodiments, for the text message advertisement campaign 300, the keywords are used in the body of a text message sent to the one or more mobile device. In some embodiments, for the email advertisement campaign 301, the keywords are used in the subject line of an email message sent to one or more email accounts. In some embodiments, for the print advertisement campaign 302, the keywords are used in the text of the print advertisement. In some embodiments, for the phone advertisement campaign 303, the keywords are used in the message for the phone advertisement.

### Process

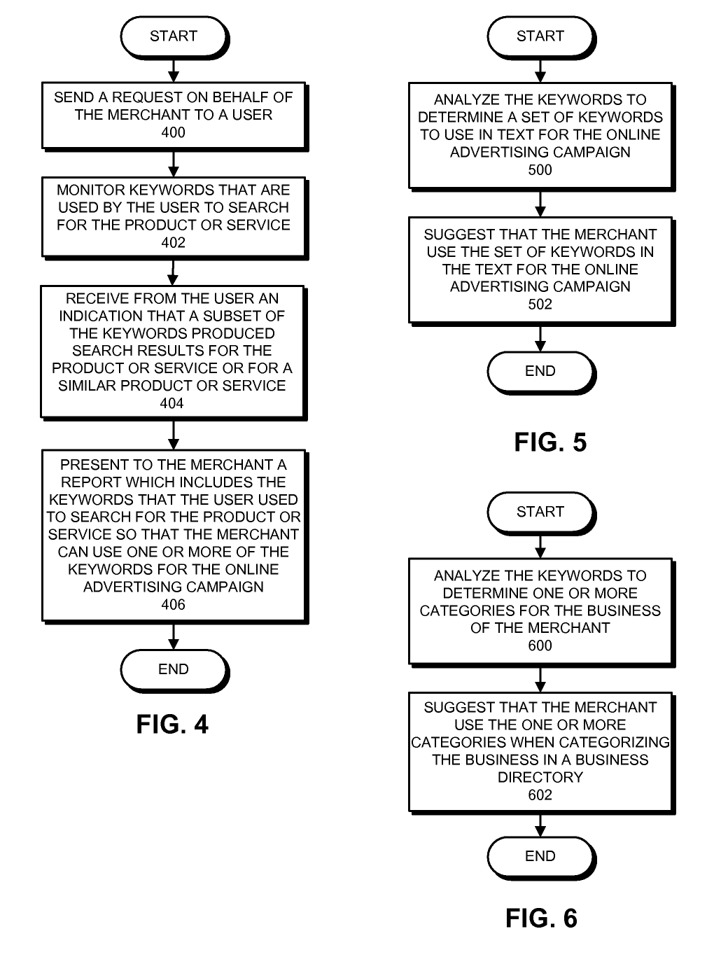

FIG. 4 presents a flow chart illustrating the process of determining keywords to be used in an online advertising campaign for a merchant in accordance with an embodiment of the present invention. The process begins when the system sends a request on behalf of the merchant to a user (step 400), wherein the request asks the user to search for a product or service offered by the merchant. In response to the request, the system monitors keywords that are used by the user to search for the product or service (step 402). Next, the system receives from the user an indication that a subset of the keywords produced search results for the product or service or for a similar product or service (step 404). The system then presents to the merchant a report which includes the keywords that the user used to search for the product or service so that the merchant can use one or more of the keywords for the online advertising campaign (step 406).

FIG. 5 presents a flow chart illustrating the process of suggesting keywords for text associated with an online advertising campaign in accordance with an embodiment of the present invention. The process begins when the system analyzes the keywords to determine a set of keywords to use in text for the online advertising campaign (step 500). The system then suggests that the merchant use the set of keywords in the text for the online advertising campaign (step 502).

FIG. 6 presents a flow chart illustrating the process of suggesting categories for a business accordance with an embodiment of the present invention. The process begins when the system analyzes the keywords to determine one or more categories for the business of the merchant (step 600). The system then suggests that the merchant use the one or more categories when categorizing the business in a business directory (step 602). In some embodiments, the business directory can include, but is not limited to, an Internet website directory and a yellow pages directory.

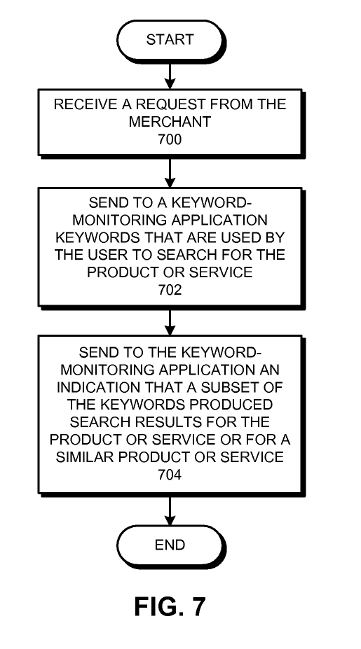

FIG. 7 presents a flow chart illustrating another process of determining keywords to be used in an online advertising campaign for a merchant in accordance with an embodiment of the present invention. The process begins when the system receives a request from the merchant (step 700), wherein the request asks a user to search for a product or service offered by the merchant. In response to the request, the system sends application keywords that are used by the user to search for the product or service to a keyword-determination system (step 702). The system then sends to the keyword-determination system an indication that a subset of the keywords produced search results for the product or service or for a similar product or service (step 704). These keywords are used by the keyword-determination system to generate a report which is presented to the merchant, and wherein the report includes the keywords that the user used to search for the product or service. The merchant can then use the one or more of the keywords for the online advertising campaign.

The foregoing descriptions of embodiments of the present invention have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method for determining keywords to be used in an online advertising campaign for a merchant, comprising:
sending a request on behalf of the merchant to a user, wherein the request asks the user to search for a product or service offered by the merchant;
in response to the request, monitoring keywords that are used by the user to search for the product or service;
receiving from the user an indication that a subset of the keywords produced search results for the product or service or for a similar product or service; and
presenting to the merchant a report which includes the keywords that the user used to search for the product or service so that the merchant can use one or more of the keywords for the online advertising campaign.

2. The method of claim 1, further comprising presenting a web page which allows the merchant to purchase the keywords for the online advertising campaign.

3. The method of claim 1, wherein the user can include one or more of:
the merchant;
a customer of the merchant;
a potential customer of the merchant;
an employee of a business;
a family member of the merchant;
a friend of the merchant;
any other person or entity capable of responding to the request.

4. The method of claim 1,
wherein sending the request to the user involves sending the request to one or more users; and
wherein the method further comprises obtaining contact information for the one or more users from one or more of:
an account for the merchant within a social network application;
an address book for the merchant;
an email contact list for the merchant; and
a customer list for the merchant.

5. The method of claim 1, wherein prior to sending the request on behalf of the merchant to the user, the method further comprises generating the request which prompts the user to search for the product or service offered by the merchant.

6. The method of claim 5, wherein the prompt does not include a business name for the merchant.

7. The method of claim 1, wherein sending the request on behalf of the merchant to the user involves sending the request using one or more of:
an email message;
a message on a website for the merchant;
a link on the website for the merchant;
a system that displays the request to users;
a text message;
a phone call; and
a piece of postal mail.

8. The method of claim 1, wherein the report includes one or more of:
a history of keywords used by the user to search for the product or service;
a history of pages that the user visited while searching for the product or service; and
the subset of keywords that produced search results for the product or service or for a similar product or service.

9. The method of claim 1, wherein the keywords include geographic information.

10. The method of claim 1, further comprising:
analyzing the keywords to determine a set of keywords to use in text for the online advertising campaign; and
suggesting that the merchant use the set of keywords in the text for the online advertising campaign.

11. The method of claim 1, further comprising:
analyzing the keywords to determine one or more categories for the business of the merchant; and
suggesting that the merchant use the one or more categories when categorizing the business in a business directory.

12. The method of claim 1,
wherein the online advertising campaign is an email advertisement campaign; and
wherein the keywords are used in a subject line of an email message for the email advertisement campaign.

13. The method of claim 1,
wherein the online advertising campaign is to be displayed along with search results produced by a search engine; and
wherein the keywords are associated with the online advertising campaign.

14. A computer-readable storage medium storing instructions that when executed by a computer cause the computer to perform a method for determining keywords to be used in an online advertising campaign for a merchant, wherein the method comprises:
sending a request on behalf of the merchant to a user, wherein the request asks the user to search for a product or service offered by the merchant;
in response to the request, monitoring keywords that are used by the user to search for the product or service;
receiving from the user an indication that a subset of the keywords produced search results for the product or service or for a similar product or service; and
presenting to the merchant a report which includes the keywords that the user used to search for the product or service so that the merchant can use one or more of the keywords for the online advertising campaign.

15. The computer-readable storage medium of claim 14, wherein the method further comprises presenting a web page which allows the merchant to purchase the keywords for the online advertising campaign.

16. The computer-readable storage medium of claim 14, wherein the user can include one or more of:
the merchant;
a customer of the merchant;
a potential customer of the merchant;
an employee of a business;
a family member of the merchant;
a friend of the merchant; and
any other person or entity capable of responding to the request.

17. The computer-readable storage medium of claim 14,
wherein sending the request to the user involves sending the request to one or more users; and
wherein the method further comprises obtaining contact information for the one or more users from one or more of:
an account for the merchant within a social network application;
an address book for the merchant;
an email contact list for the merchant; and
a customer list for the merchant.

18. The computer-readable storage medium of claim 14, wherein the report includes one or more of:
a history of keywords used by the user to search for the product or service;
a history of pages that the user visited while searching for the product or service; and
the subset of keywords that produced search results for the product or service or for a similar product or service.

19. The computer-readable storage medium of claim 14, wherein the method further comprises:
analyzing the keywords to determine a set of keywords to use in text for the online advertising campaign; and
suggesting that the merchant use the set of keywords in the text for the online advertising campaign.

20. The computer-readable storage medium of claim 14, wherein the method further comprises:
analyzing the keywords to determine one or more categories for the business of the merchant; and
suggesting that the merchant use the one or more categories when categorizing the business in a business directory.

21. The computer-readable storage medium of claim 14,
wherein the online advertising campaign is an email advertisement campaign; and
wherein the keywords are used in a subject line of an email message for the email advertisement campaign.

22. The computer-readable storage medium of claim 14,
wherein the online advertising campaign is to be displayed along with search results produced by a search engine; and
wherein the keywords are associated with the online advertising campaign.

23. An apparatus that determines keywords to be used in an online advertising campaign for a merchant, comprising:
a sending mechanism configured to send a request on behalf of the merchant to a user, wherein the request asks the user to search for a product or service offered by the merchant;
a monitoring mechanism, wherein in response to the request, the monitoring mechanism is configured to monitor keywords that are used by the user to search for the product or service;
a receiving mechanism configured to receive from the user an indication that a subset of the keywords produced search results for the product or service or for a similar product or service; and
a presentation mechanism configured to present to the merchant a report which includes the keywords that the user used to search for the product or service so that the merchant can use one or more of the keywords for the online advertising campaign.

24. A system that determines keywords to be used in an online advertising campaign for a merchant, comprising:
a client system;
a search engine configured to produce search results and advertisements based on search terms;
a keyword-determination system which is configured to:
send a request on behalf of the merchant to a user at the client system, wherein the request asks the user to use the search engine to search for a product or service offered by the merchant;
monitor keywords that are used by the user to search for the product or service;
receive from the user an indication that a subset of the keywords produced search results for the product or service or for a similar product or service; and
present to the merchant a report which includes the keywords that the user used to search for the product or service so that the merchant can use one or more of the keywords for the online advertising campaign.

25. A method for determining keywords to be used in an online advertising campaign for a merchant, comprising:
receiving a request from the merchant, wherein the request asks a user to search for a product or service offered by the merchant;
in response to the request, sending keywords that are used by the user to search for the product or service to a keyword-determination system;
sending to the keyword-determination system an indication that a subset of the keywords produced search results for the product or service or for a similar product or service, wherein the keywords are used by the keyword-determination system to generate a report which is presented to the merchant, wherein the report includes the keywords that the user used to search for the product or service, and wherein the merchant can use the one or more of the keywords for the online advertising campaign.
